(19) United States
(12) Patent Application Publication
(10) Pub. No.: US 2024/0119377 A1
(43) Pub. Date: Apr. 11, 2024

(54) SYSTEM FOR CREATING RESERVATION WORK SCHEDULE AS PUZZLE AND MANAGING SAME

(71) Applicant: Tak LEE, Seoul (KR)

(72) Inventor: Tak LEE, Seoul (KR)

(21) Appl. No.: 18/495,819

(22) Filed: Oct. 27, 2023

Related U.S. Application Data
(63) Continuation-in-part of application No. PCT/KR2021/019744, filed on Dec. 3, 2021.

(30) Foreign Application Priority Data
Apr. 30, 2021 (KR) 10-2021-0056419

(51) Int. Cl. G06Q 10/0631; G06Q 10/1093

(52) U.S. Cl. CPC G06Q 10/063116; G06Q 10/1097

(57) ABSTRACT

A system for puzzling and managing a reservation work schedule is disclosed. The system comprises a reservation schedule management unit for creating and managing a service person's daily reservation work schedule according to service reservations from customers, but for managing the reservation work schedule by block-element puzzling the reservation work schedule according to the reserved service items.

### TECHNICAL FIELD

The present invention relates to a technology for managing work schedules, and more particularly, to a technology for managing reservation work schedules of service industry workers.

### BACKGROUND ART

Korean Patent Registration No. 10-1915814 discloses a beauty shop management server. The beauty shop management server receives reservation information including at least one of customer information, reservation time information, treatment information, payment information and responsible person information from a manager terminal, and schedules treatment schedules of staffs based on the received reservation information and provides the scheduled staffs treatment schedule to the manager terminal. Through this, the manager can easily grasp and manage the staff's treatment schedules.

On the other hand, while there are treatment items that the beautician must continuously provide services without being separated from the customer from beginning to end, there are also treatment items that the beautician does not need to be directly involved during a certain period of time. For example, in the case of a perm, a certain amount of time must be waited after applying perm to the customer's hair, and this waiting time becomes idle time for the beautician. Conventionally, in consideration of such idle time, the treatment service is provided by receiving duplicate reservations from customers, but it is difficult to expect systematic schedule management and there also arise problems that cause complaints due to unintended long waits of customers.

### DISCLOSURE OF INVENTION

### Technical Problem

An object of the present invention is to provide a way for more intuitively and systematically managing a reservation work schedule of a service person.

### Technical Solution

According to one aspect, a system for puzzling and managing a reservation work schedule comprises a reservation schedule management unit for creating and managing a service person's daily reservation work schedule according to service reservations from customers, but for managing the reservation work schedule by block-element puzzling the reservation work schedule according to the reserved service items.

The system for puzzling and managing a reservation work schedule further comprises a block element database having block-shaped elements defined therein in which the total required service time for each service item is represented and when the idle time of the service person exists among the total required service time, the idle time is also represented, wherein the schedule management unit can puzzle the reservation work schedule by reflecting the block elements mapped to reservation service items of customers in the corresponding reservation time on the reservation work schedule.

The block elements may be divided into a basic block element in which the total required service time is represented and a variant block element that the total required service time and idle time are represented. In addition, the variant block element consists of a time bar representing the total required service time and one or more work bars extending from a part of the time bar, but orthogonal to the time bar and representing a work section of a service person and thus the idle time can be represented as an idle section other than the work section.

### Advantageous Effects

The present invention creates an effect that enables intuitive and systematic schedule management by block element-puzzling a reservation work schedule of a service person. In particular, with regard to the service item in which the service person's idle time exists, the present invention enables a clear management of the idle time of the service person by reflecting block-shaped elements in which the working time section and the idle time section are clearly divided and represented in the reservation work schedule as well as enables systematic customer reservations using idle time. Furthermore, the present invention proposes a puzzle fitting scheme to prevent the corresponding puzzles from overlapping together even when reservation time zones overlap, thereby enabling more effective reservation work schedule management.

According to the present invention, there is an advantage that the customer's online reservation time is extended, and two or more customers can make an online reservation at the same time with one service person. In addition, in the service person's position, additional revenue can be obtained according to additional reservations.

### BRIEF DESCRIPTION OF DRAWINGS

FIG. 1 is a block diagram of a system for puzzling and managing a reservation work schedule according to an embodiment.

FIGS. 2(a) and 2(b) are exemplary diagrams of a basic block element and a variant block element.

FIG. 3 is an exemplary diagram of various variant block elements.

FIGS. 4 to 7 are exemplary diagrams of reservation work schedules.

FIG. 8 is an exemplary diagram for explaining block element processing.

FIGS. 9(a) and 9(b) are diagrams illustrating before and after overlapping of work sections.

FIG. 10 is a diagram illustrating hardware structure of a system for puzzling and managing a reservation work schedule.

The foregoing and further aspects of the present invention will become more apparent through preferred embodiments described with reference to the accompanying drawings. Hereinafter, the present invention will be described in detail so that those skilled in the art can easily understand and reproduce the present invention through these embodiments.

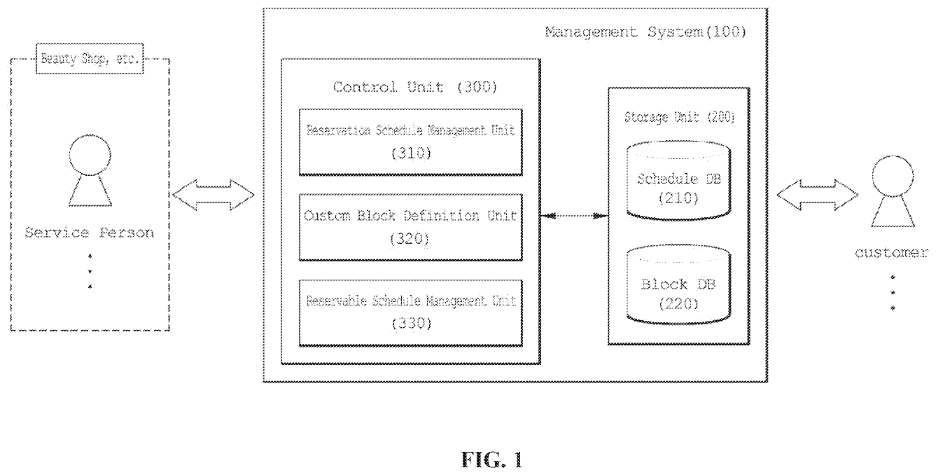

FIG. 1 is a block diagram for illustrating a system 100 for puzzling and managing a reservation work schedule. The system 100 may be, for example, a server system including one or two or more server.

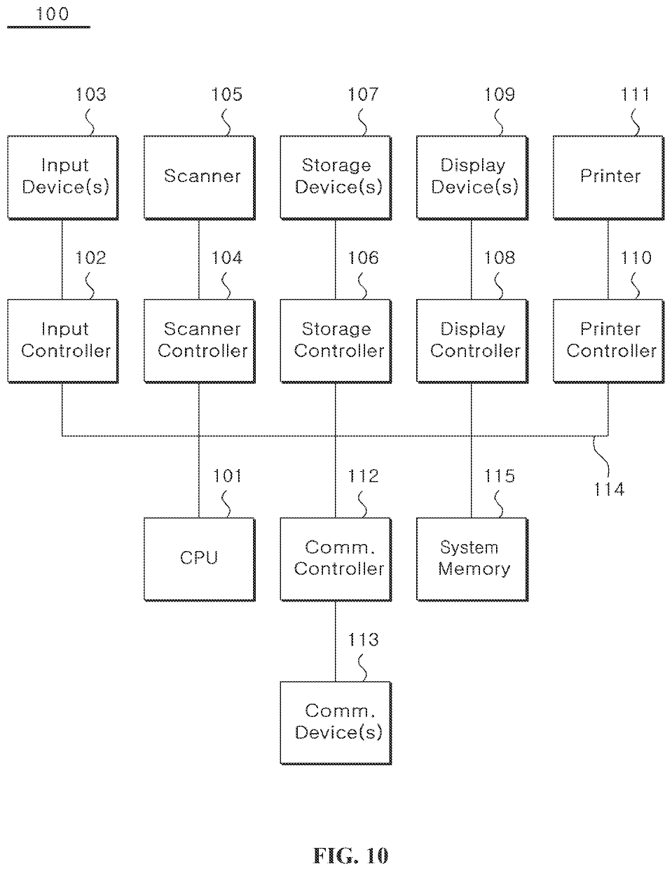

FIG. 10 illustrates the hardware structure of the system 100 for puzzling and managing a reservation work schedule.

As illustrated in FIG. 10, system 100 includes a central processing unit (CPU) 101 that provides computing resources and controls the computer. CPU 101 may be implemented with a microprocessor or the like, and may also include a graphics processor and/or a floating point coprocessor for mathematical computations. System 100 may also include a system memory 115, which may be in the form of random-access memory (RAM) and read-only memory (ROM).

A number of controllers and peripheral devices may also be provided, as shown in FIG. 10. An input controller 102 represents an interface to various input device(s) 103, such as a keyboard, mouse, or stylus. There may also be a scanner controller 104, which communicates with a scanner 105. System 100 may also include a storage controller 106 for interfacing with one or more storage devices 107 each of which includes a storage medium such as magnetic tape or disk, or an optical medium that might be used to record programs of instructions for operating systems, utilities and applications which may include embodiments of programs that implement various aspects of the present invention. Storage device(s) 107 may also be used to store processed data or data to be processed in accordance with the invention. System 100 may also include a display controller 108 for providing an interface to a display device 109, which may be a cathode ray tube (CRT), a thin film transistor (TFT) display, or other type of display. System 100 may also include a printer controller 110 for communicating with a printer 111. A communications controller 112 may interface with one or more communication devices 113, which enables system 100 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 114, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

The system 100 may provides a service for managing reservation work schedules for those engaged in professional service industries such as beauty shops. The system 100 according to one aspect may block-element puzzle and manage a reservation work schedule of a service person in accordance with reserved service items (cut, perm, dye, scalp care, etc.). In addition, the service person may receive a reservation work schedule management service by accessing the system 100 online through a web, an application or a web application using a communicable computing device. Further, the system 100 creates and manages a reservable schedule based on the reservation work schedule, thereby allowing to receive reservations from customers via phone or online in accordance with the reservable schedule.

As shown in FIG. 1, the system 100 includes a storage unit 200 and a control unit 300.

The storage unit 200 may be implemented by one or more storage devices 107. The storage unit 200 may store and manage programs, instructions, data, etc. for management and operation of the puzzle-based reservation work schedules. The controller 300 may be implemented by one or more processors 101. The control unit 300 may includes functionally distinct components, such as a reservation schedule management unit 310, and at least one of a custom block element definition unit 320 and a reservable schedule management unit 330. All of these are components that may be implemented in software and functionally distinct, and can perform a given role by being executed by a processor 101. Meanwhile, although not shown in FIG. 1, the system 100 may further include a communication unit, a user interface devices, etc. for data communication with the outside.

The reservation schedule management unit 310 creates a daily reservation work schedule of a service person in accordance with service reservations from customers and stores it in the schedule database 210 in which the reservation work schedule is block-element puzzled and managed in accordance with reserved service items. To this end, the storage unit 200 may include a block element database 220, with the nature of a user interface element. In the block element DB 220, block- shaped elements are defined and managed for each service item. For example, a block-shaped element is defined and managed for each single service item or combined service items, such as cut, perm, dye, scalp care, perm+dye, cut+perm+dye, and the like.

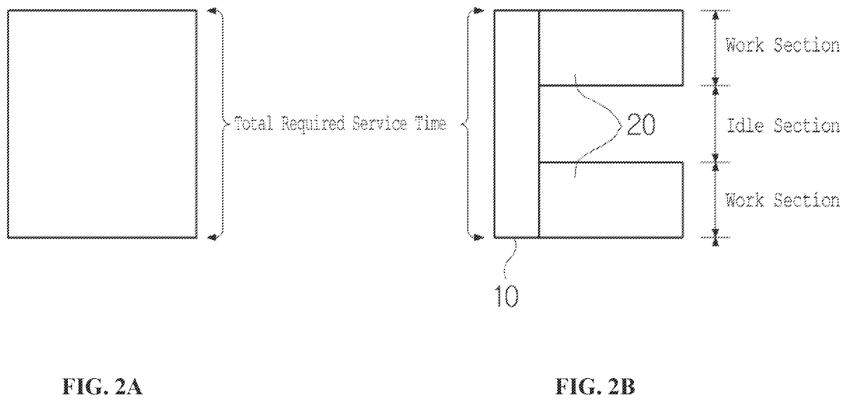

Block elements can be largely divided in a basic block element and a variant block element. The basic block element has a shape to represent the total required service time for a service item, and the variant block element has a shape to also represent the idle time of a service person if there is an idle time among the total required service time. FIG. 2 illustrates a basic block element and a variant block element. As shown in FIG. 2a, the basic block element may be a square block element. And, the total required service time can be graphically represented as the upper and lower widths of the square block element. Therefore, the longer the required time, the wider the upper and lower widths, and the shorter the required time, the narrower the upper and lower widths. In addition, representing the total required service time as the upper and lower widths of the square block element assumes that the time axis of the reservation work schedule is the vertical axis, and if the time axis is the horizontal axis, the total required service time may be represented as the left and right widths of the square block element.

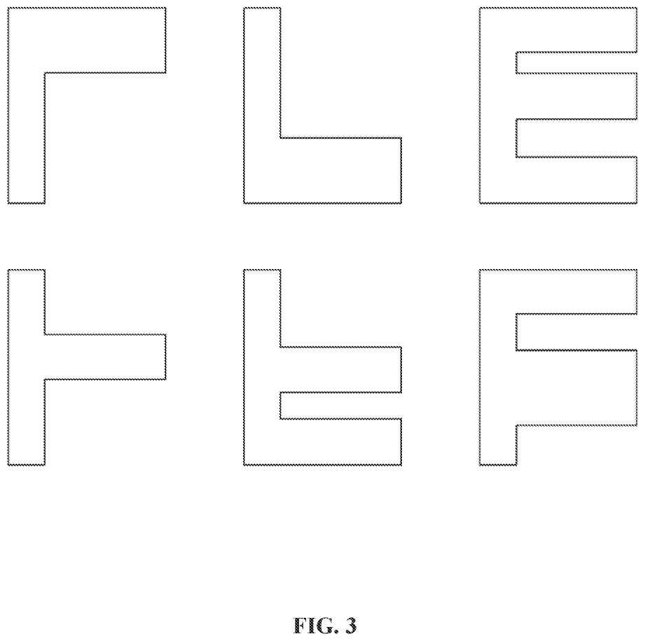

Next, the variant block can be viewed as a block deformed so that a part of the basic block element remains empty. As shown in FIG. 2(b), the variant block element may consist of a time bar 10 and one or more work bars 20. The time bar 10 is intended to represent the total required service time, and can represent the total required service time as a width similar to the basic block element. Also, the work bar 20 is intended to represent a work time section (work section) among the total required service time, and extends from a part of the time bar 10 but is orthogonal to the time bar 10. That is, the variant block element consists of a time bar 10 and one or more work bars 20 and may represent idle time of a service person in an empty section (idle time section, idle section) other than the work section. Various examples of such a variant block element are shown in FIG. 3.

Meanwhile, the block-shaped element for each service item stored in the block element DB 220 may be defined by default or may be directly defined for each service person. Because even for the same service item, the total required service time, work section and idle section may be different depending on the service person, it is configured to allow the service person to directly define the block-shaped element for each service item. To this end, the controller 300 may further include a custom block element definition unit 320.

In one embodiment, when the total required service time for each service item and time information on the work section or idle section are input from the service person, the custom block element definition unit 320 automatically defines a block-shaped element corresponding thereto and manages it through the block element DB 220. That is, in the block element DB 220, a block-shaped element may be defined and managed for each service item of each service person. The block-shaped element for each service item defined once is not unchangeable. That is, the custom block element definition unit 320 may change the block-shaped element for each service item of each service person and newly define it. In addition, the custom block element definition unit 320 may define a block-shaped element for each customer and each service item of each service person and manage it in the block element DB 220. That is, a block-shaped element can be also defined for each customer for each service item.

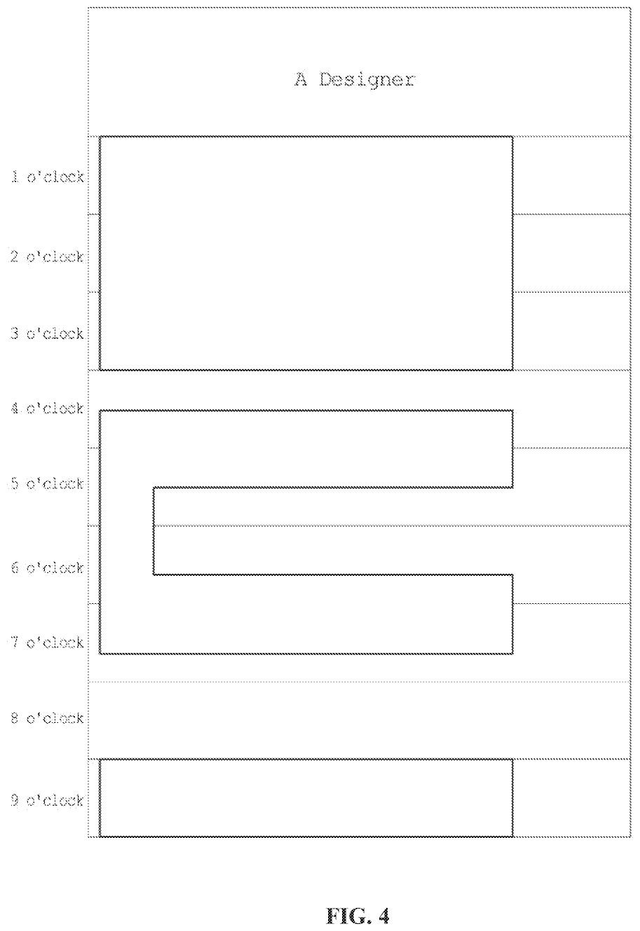

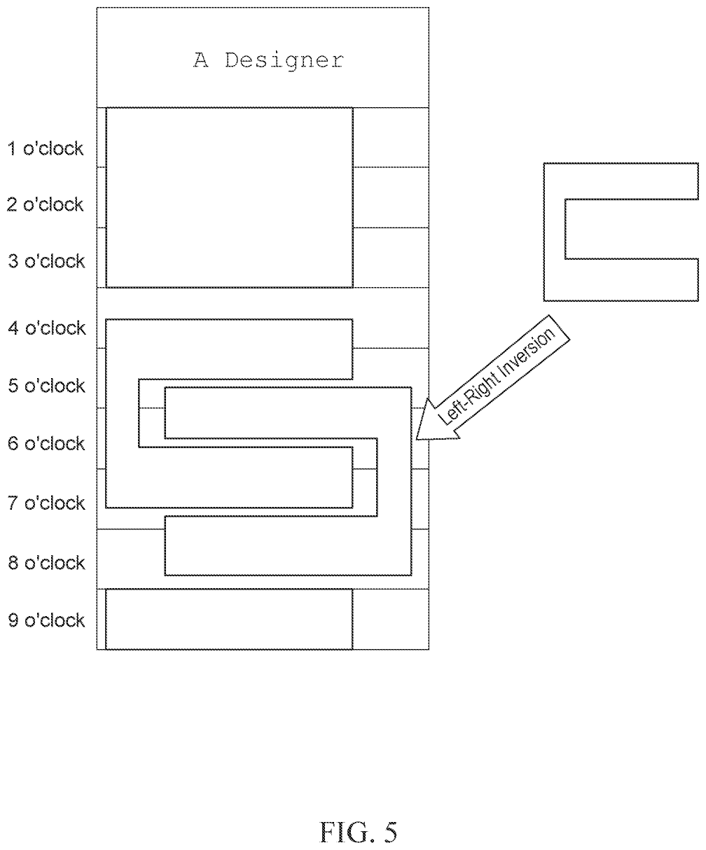

The reservation schedule management unit 310 based on the block element DB 220 will be described. In one embodiment, the reservation schedule management unit 310 reflects the corresponding block elements defined in the block element DB 220 in accordance with the service items reserved by customers to the corresponding reservation time on the service person's reservation work schedule. An example of this is shown in FIG. 4. As shown in FIG. 4, when the variant block element is reflected on the reservation work schedule and the schedule is represented, the idle time of the service person during the corresponding scheduled working time can be easily identified, and thus systematic schedule management as well as additional reservation receipt and management in consideration of the idle time become easy. That is, in FIG. 4, the idle time of the variant block element is identified, and accordingly, as shown in FIG. 5, a new reservation (niche reservation using the idle time) can be additionally received.

As shown in FIG. 5, when a block element overlapping problem occurs, the reservation schedule management unit 310 may invert the block element and reflect the inverted block element in the reservation work schedule. In one embodiment, when two variant block elements that at least part of the reservation time overlaps satisfy a preset inversion condition, the reservation schedule management unit 310 inverts one variant block element and then reflects the inverted variant block element in the corresponding reservation time on the reservation work schedule to thereby allow the two variant block elements to be fitted by a puzzle through an idle section without overlapping each other. The block element inversion may be a left-right inversion as shown in FIG. 5, but this is considered when the time axis is a vertical axis, and may be an up-down inversion if the time axis is represented in a horizontal axis. That is, the reservation work schedule of FIG. 5 can be represented as being rotated by 90 degrees in a counterclockwise direction, and in that case, the block element inversion may be an up-down inversion.

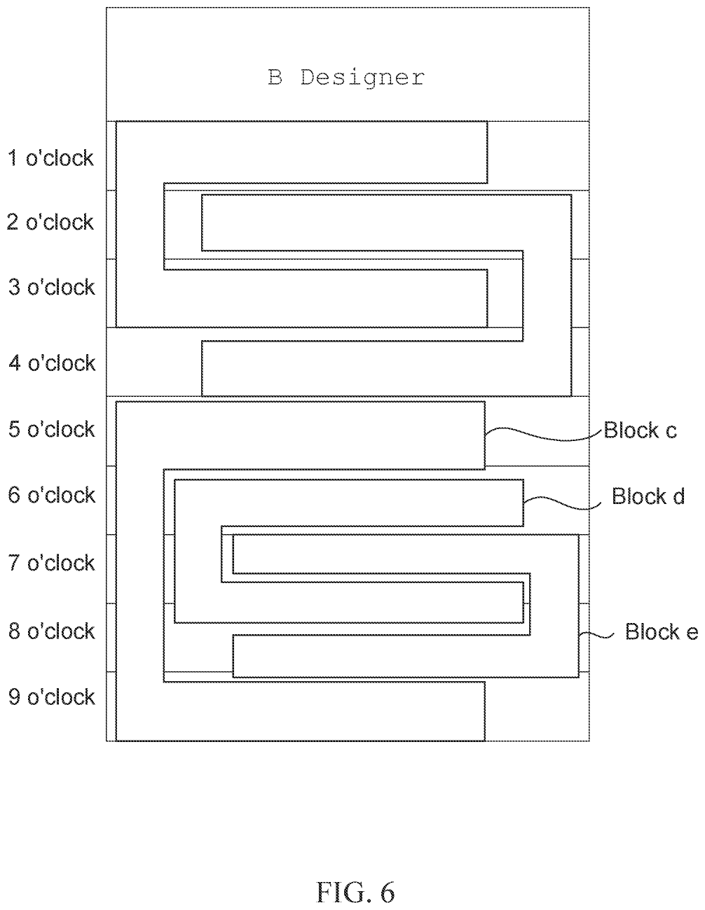

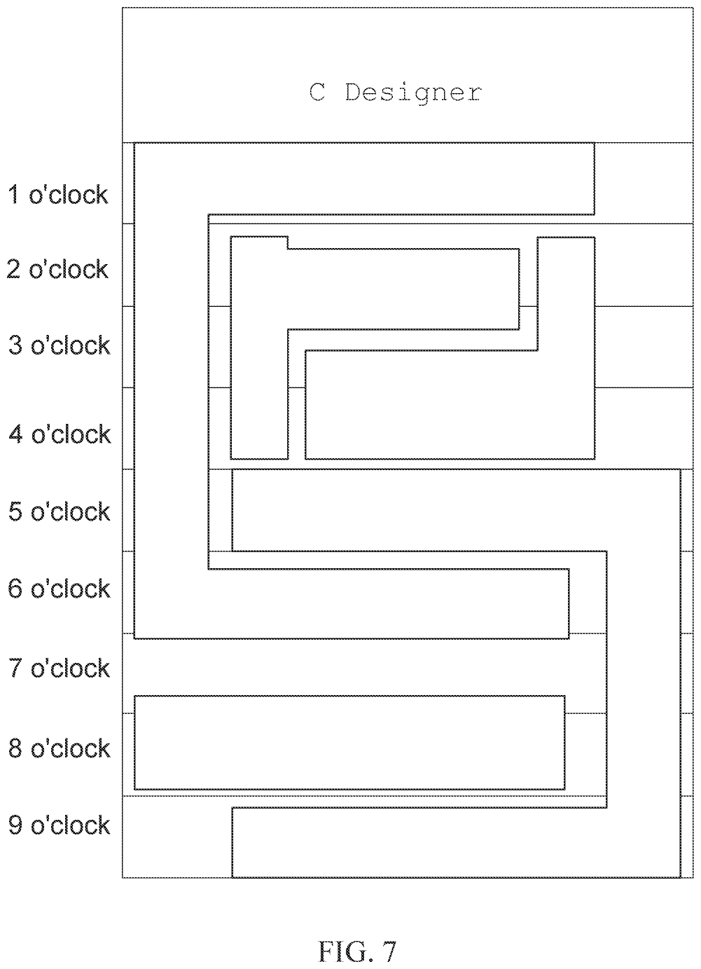

On the other hand, the inversion condition may mean that the work sections of the two variant block elements (block element a, block element b) do not overlap each other, and the total required service time of any one variant block element (block element a or block element b) of the two variant block elements does not belong to the idle time of the other variant block element (block element b or block element a). In other words, it may mean that the idle time of one variant block element belongs to the total required service time of the other variant block element. According to this, it can be confirmed that in FIG. 6, block element c and block element d have an overlapping reservation time, but do not satisfy the inversion condition and resultantly the block element inversion has not occurred, whilst block element d and block element e have an overlapping reservation time and do satisfy the inversion condition and resultantly the block element e has been inverted.

The reservable schedule management unit 330 creates and manages reservable schedules for each service item in which the reservable schedule management unit 330 may create a reservable schedule for each service person and store the created schedule in the schedule DB 210 for management. In one embodiment, the reservable schedule management unit 330 creates, when a variant block element exists on a reservation work schedule being managed through the schedule DB 210 and a service item which is workable using the idle time of the variant block element exists, a reservable schedule for the corresponding service item in consideration of the idle time. That is, the reservable schedule is created considering both the time vacated between block elements and the idle section of the variant block element.

The reservable schedule management unit 330 provides a reservable schedule as graphic data to the beauty shop manager's terminal (i.e., smartphone, laptop, tablet or desktop computer) so that the beauty shop manager can use it when receiving phone reservation, etc. from customers. In this case, the reservation schedule management unit 310 may receive reservation information from the beauty shop manager and reflect the reservation information in a corresponding block element on the reservation work schedule of the corresponding service person. For reference, the beauty shop manager may be designated from among service persons and all service persons may become the beauty shop manager. Also, the reservable schedule management unit 330 may provide a reservable schedule to customers who have accessed online so that customers can make a direct online reservation or provide the reservable schedule to a server (for example, Naver reservation platform) that acts as an agent for online reservation so that customers can make a direct online reservation. In this case, the reservation schedule management unit 310 may reflect the reservation information input from the online-connected customer or the reservation information received from the reservation agent server in a corresponding block element in the reservation work schedule of the service person.

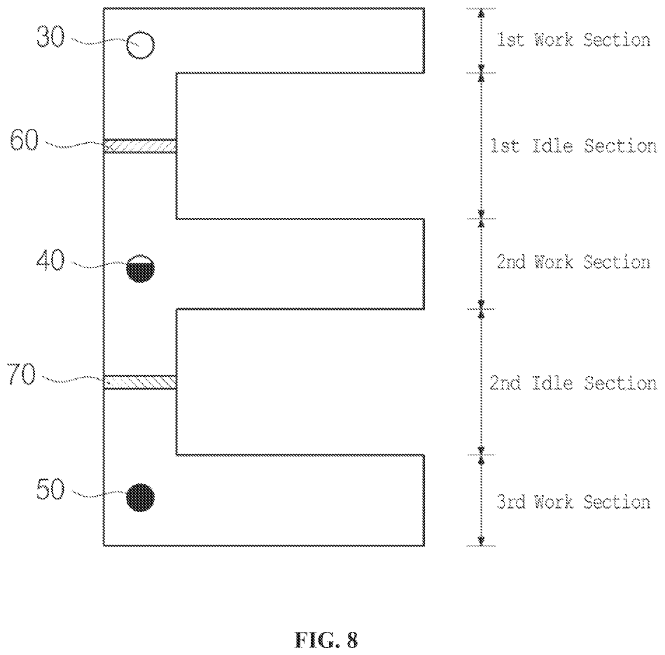

FIG. 8 is an exemplary diagram for explaining block element processing. The block element may include graphic objects 30, 40, 50, 60, and 70 capable of adjusting the block-shaped element. In FIG. 8, the circular objects 30, 40 and 50 are objects for adjusting the widths of work sections, and the user can adjust the width of the corresponding work section by manipulating the circular objects. In addition, the bar objects 60 and 70 are objects for adjusting the width of idle sections, and the user can adjust the width of the corresponding idle section by manipulating the bar objects. These graphic objects are exemplary and can be implemented in various ways. In addition, unlike FIG. 8, the graphic objects may not appear in the block element, and the width of the corresponding section may be adjusted by the user's manipulation such as touch & drag of a predetermined position. In addition, such section width adjustment may be performed on a work reservation schedule. That is, the reservation schedule management unit 310 may process the corresponding section to be adjusted according to the input of the service person for adjusting the section of the block element reflected in the reservation work schedule.

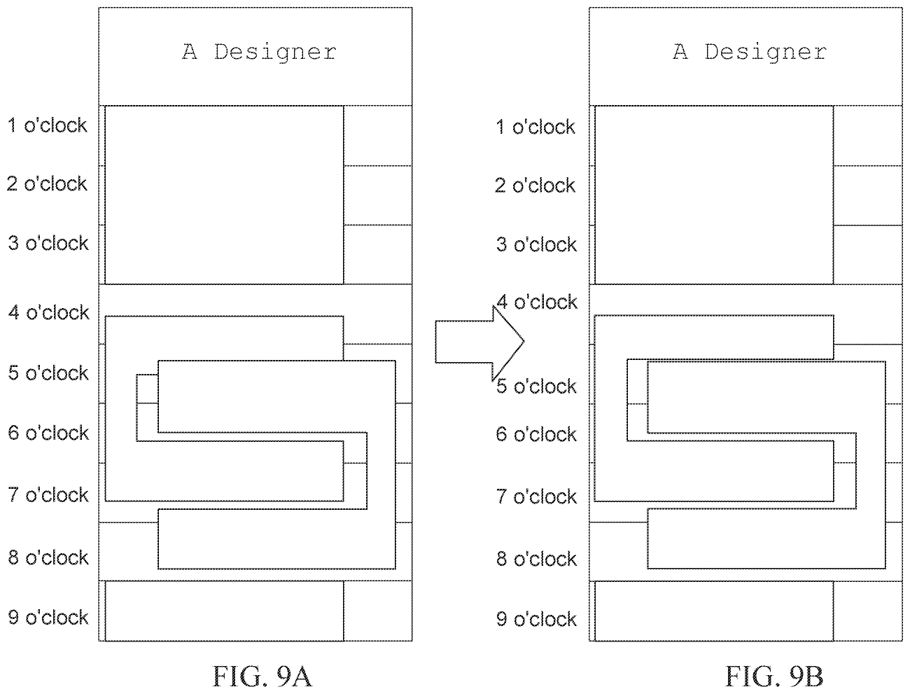

On the other hand, unlike the above-described example, the inversion condition may mean that the total required service time of one variant block element does not belong to the idle time of the other variant block element, regardless of whether the work sections of the two variant block elements overlap. However, in this case, although there would occur a problem in which the work section between the two block elements partially overlaps as shown in FIG. 9(a), but the service person may directly adjust the section as shown FIG. 9(b) to thereby address the overlapping problem.

Although the term ‘DB’ has been used above, it is a broad term referring to tools for storing and retrieving data. It should not be limited to that specific term; it should be interpreted as encompassing both repositories and databases.

So far, the present invention has been described focusing on preferred embodiments thereof. Those skilled in the art to which the present invention pertains will be able to understand that the present invention can be implemented in a variant form without departing from the essential features of the present invention. Therefore, the disclosed embodiments should be considered from an illustrative point of view rather than a limiting point of view. The scope of the present invention is set forth in the claims rather than the foregoing description, and all differences within the equivalent range should be construed as being included in the present invention.

What is claimed is:

1. A system for puzzling and managing reservation work schedule comprises a reservation schedule management unit for creating and managing a service person's daily reservation work schedule according to service reservations from customers, but for managing the reservation work schedule by block-element puzzling the reservation work schedule according to the reserved service items.

2. The system according to claim 1, further comprises a block element database having block-shaped elements defined therein in which the total required service time for each service item is represented and when the idle time of the service person exists among the total required service time, the idle time is also represented, wherein the schedule management unit puzzles the reservation work schedule by reflecting the block elements mapped to reservation service items of customers in the corresponding reservation time on the reservation work schedule.

3. The system according to claim 2, wherein the block elements are divided into a basic block element in which the total required service time is represented and a variant block element in which the total required service time and idle time are represented, and wherein the variant block element consists of a time bar representing the total required service time and one or more work bars orthogonally extending from a part of the time bar and representing a work section of a service person, and represents the idle time as an idle section other than the work section.

4. The system according to claim 3, wherein the reservation schedule management unit inverts, when two variant block elements in which at least part of the reservation time overlaps satisfy a preset inversion condition, one variant block element and then reflects the inverted variant block element in the reservation work schedule to thereby allow the two variant block elements to be fitted by a puzzle through an idle section.

5. The system according to claim 4, wherein the preset inversion condition means that the work sections of the two variant block elements overlap each other, and the total required service time of any one variant block element of the two variant block elements does not belong to the idle time of the other variant block element.

6. The system according to claim 2, further comprising reservable schedule management unit, wherein the reservable schedule management unit creates, when a variant block element exists on a reservation work schedule and a service item which is workable using the idle time exists, a reservable schedule for the corresponding service item in consideration of the idle time.
